(19) United States
(12) Patent Application Publication
(10) Pub. No.: US 2013/0327959 A1
(43) Pub. Date: Dec. 12, 2013

(54) METHODS AND SYSTEMS FOR PRODUCING SURFACE-CONDUCTIVE LIGHT-RESPONSIVE NANOPARTICLE-POLYMER COMPOSITES

(71) Applicant: Glen Leon Brizius, Augusta, GA (US)

(72) Inventor: Glen Leon Brizius, Augusta, GA (US)

(73) Assignee: EMPIRE TECHNOLOGY DEVELOPMENT LLC, Wilmington, DE (US)

(21) Appl. No.: 13/641,169

(22) PCT Filed: Jun. 11, 2012
(86) PCT No.: PCT/US12/41881

§ 371 Date: Oct. 15, 2012

(51) Int. Cl. B05D 5/00; G01N 21/64; B05D 3/06

(52) U.S. Cl. CPC B05D 5/00; B05D 3/06; B05D 3/065; G01N 21/64
USPC 250/461.1; 427/532; 427/557; 427/558; 250/458.1

(57) ABSTRACT

Methods are disclosed for fabricating a metallic nanoparticle-polymer composite film having a metallic nanoparticle interlayer of uniform depth. The uncured polymer resin may be mixed with a metal dopant and cast as a film. The film may then be dried and exposed to uniform illumination having a wavelength from about 490 nm to about 570 nm. The dried and illuminated film may then be heat cured to produce the composite. In addition, a system for uniformly illuminating a composite film is also disclosed. The system may include a flat support on which the film may be placed. A second flat support may be placed above the film. The second support may incorporate a uniform thin layer of light-emitting material on the support side not contacting the film. The system may further comprise a source of illumination at an excitation wavelength capable of causing the light-emitting material to illuminate the film.

### BACKGROUND

The ease of use of a machine may be directly correlated to the ease of the human user to interact with the interface device associated with the machine. One example of an electronic user interface is the touch-based screen. This interface may be fairly intuitive for a user to operate, and may respond rapidly. Instead of a user typing text commands on a keyboard, a user may simply touch a screen displaying a simple-to-understand graphical icon. In many instances, human-computer interfaces, such as many types of touch screens, may depend on rigid silicon-based circuitry. Not only are such interfaces potentially fragile, but their size (surface area) may be limited due to the difficulty of manufacturing large surface area devices with uniform characteristics. There is a need for new materials which can provide physical flexibility to user interfaces, while simultaneously retaining their electronic and optical characteristics, such as conductivity and optical transparency.

Flexible user interfaces can have several advantages over rigid (normally inorganic-based) user interfaces. Cost may be a primary advantage. A large-area, rigid interface with uniform characteristics can be expensive to produce in number. Additionally, such rigid interfaces may be fragile, especially at large dimensions. A large-area flexible interface possessing high surface conductivity can be used with applications requiring capacitive and/or resistive sensing. Further, due to their inherent flexibility, such devices may also possess a longer lifetime since they may be less susceptible to accidental damage due to physical jarring or even everyday use. Flexible electronic and optical devices may find application in a number of displays, circuitry, and even power supplies. Development of such devices may depend on innovative methods and systems for producing flexible electronic and/or optical materials in a fast, low cost fashion.

### SUMMARY

In an embodiment, a method of fabricating a nanoparticle-polymer composite may comprise providing an uncured liquid polymer resin, providing at least one metal dopant, combining the uncured liquid polymer resin with the at least one metal dopant to form a liquid polymer/metal mixture, casting a film of the liquid polymer/metal mixture onto a flat support, drying the film, illuminating the dried film with radiation having at least one wavelength from about 490 nm to about 570 nm, and heating the illuminated film.

In an embodiment, a system to uniformly illuminate a film may comprise a first flat support having a first side and a second flat support having a first side and a second side. The second side of the second flat support may be coated with an effectively uniform thickness of at least one light-emitting material, and the second flat support may further comprise at least one material effectively transparent to radiation having at least one wavelength of light emitted by the light-emitting material. In at addition, the system may further include at least one source of an excitation radiation configured to cause the at least one light-emitting material to emit the radiation.

### BRIEF DESCRIPTION OF THE DRAWINGS

FIG. 1 illustrates an embodiment of a nanoparticle-polymer composite film in accordance with the present disclosure.

FIG. 2 illustrates an embodiment of a nanoparticle-polymer composite film responding to a radiation stimulus in accordance with the present disclosure.

FIG. 3 is a flow chart of an embodiment of a method of fabricating a nanoparticle-polymer composite film in accordance with the present disclosure.

FIG. 4 illustrates a system for uniformly illuminating a film in accordance with the present disclosure.

### DETAILED DESCRIPTION

Flexible materials comprising both optical and conductive properties may include thin organic polymer films impregnated with conductive materials such as metals. If the conductive materials, as nanoparticles, are disposed inhomogeneously in the polymer film, the resulting material may display unique physical and electronic properties. For example, a polyimide film doped with a palladium salt may be fabricated to have a single surface displaying conductive properties, while the opposing surface may be an insulator. Such a film may have the conducting surface effectively coated with palladium metal, while the opposite non-conducting surface may be free of such metal. A film may also be fabricated having a thin layer of palladium nanoparticles (an interlayer) deposited at a specific depth within the film. Light impinging on the polymer surface may be refracted or reflected depending on the relationship between the light wavelength and the depth of the interlayer, thereby making the side closest to the interlayer to appear to be red or violet. Thus, a side of a film closest to the interlayer may be referred to as the “colored” side due to this effect.

One embodiment of a method to fabricate such an interlay may include exposing the polymer film containing a metal dopant to radiation before the polymer is cured. It is believed that the depth of the interlayer may be related to the spectral flux density of the illuminating radiation. It may be appreciated that a source of radiation that produces non-uniform flux density across the film surface may result in a non-uniform deposition of nanoparticles within the interlayer. Specifically, the interlayer may be deposited at a non-uniform depth within the film. The lack of uniform deposition of the interlayer may result in non-uniform responsiveness of the film to stimuli.

It has been hypothesized that the interlayer may be formed according to the Gurney-Mott theory, which has been used to explain film photography. Films having a metal interlayer may be formed by exposing polyimide films containing metal chlorides to light in the UV range, for example light with a wavelength of about 350 nm. However, exposure of such films to UV range light may also result in the film becoming brittle due to destruction of the polyimide polymer by the UV photons.

Recent experimental work has revealed the unexpected result that thin polymer films containing metal chloride dopants may also develop metal interlayers when exposed to light in the green range of the spectrum (around 510 nm). A polyimide film exposed to visible light may not suffer from the photo-induced structural degradation of the polymer bonds that can result from exposure to UV radiation. As a result, nanoparticle-polymer films exposed to visible (including green) light may retain their flexible characteristics.

Disclosed below are a method and a system based on uniform green light illumination for producing a flexible nanoparticle-polymer composite film having a conductive surface and a metallic interlayer of uniform depth.

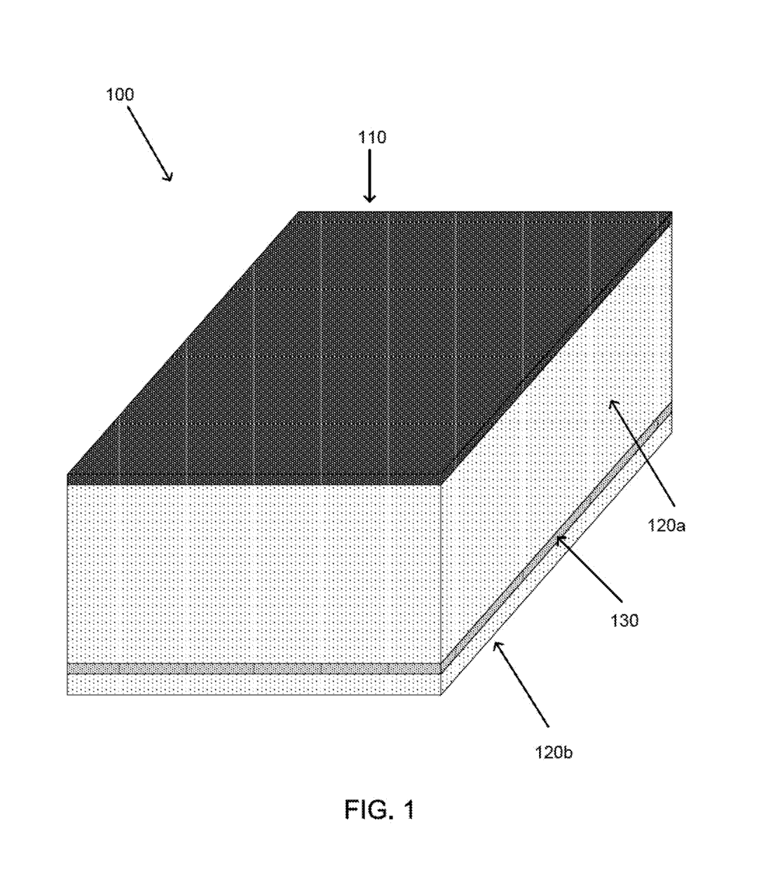

FIG. 1 illustrates an embodiment of a polymer film 100 possessing both a surface conducting layer and an interlayer. The film may comprise a polymer matrix 120a-b in which a metal material is doped. The film may then be processed in such a manner so that one surface 110 is effectively coated with the metal, thereby becoming a conductive surface. Further, the film may also be processed so that an interlayer of metal nanoparticles 130 may be disposed at a uniform depth from the non-conducting surface. The resulting film may thus comprise a multi-layered structure of a polymer layer 120b, a metal interlayer 130, a second polymer layer 120a, and a conductive layer 110.

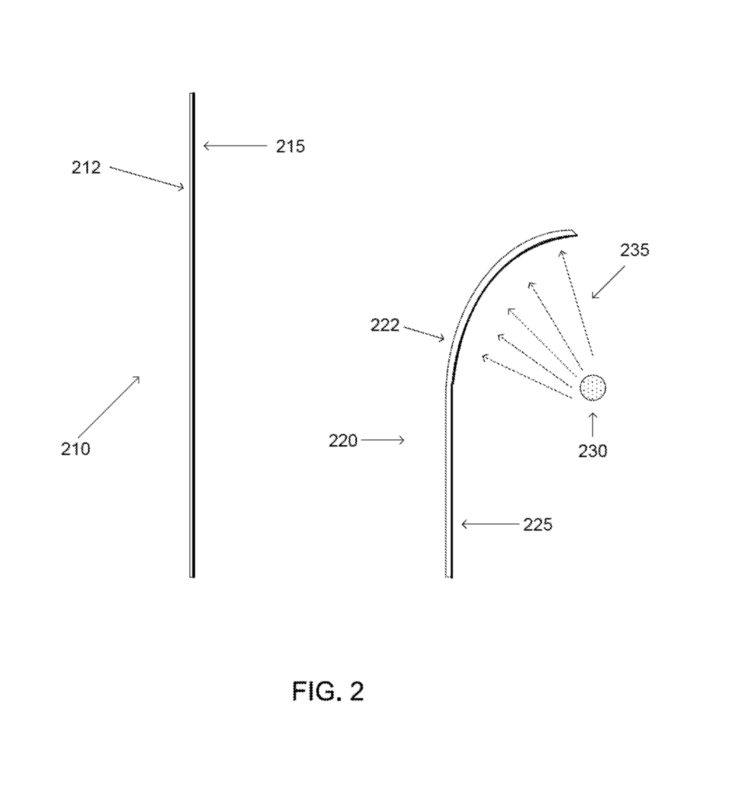

In addition to the possible optical and electronic properties of a film such as one illustrated in FIG. 1, the nanoparticle-polymer composite film may also demonstrate unique physical properties. FIG. 2 illustrates an edge view of a composite film depicted in FIG. 1. Under conditions in which the film is not illuminated, the film—having a conducting side 215 and a non-conducting side 212—may have a flat profile 210. Although not illustrated in this figure, the non-conducting or colored side 212 is closest to the interlayer. Under strong illumination 235, such as may be provided by a bright source of white light 230, the film may bend 220. It has been observed that the film may bend towards the metal-coated or conductive side 225, and away from the colored side 222. This behavior has been observed regardless of the side being illuminated. Thus, 220 is illustrated bending towards light source 230 in FIG. 2, because light source 230 illuminates the conductive side 225 of the film. However, the film may bend away from the light source if the light source illuminates the colored side 222.

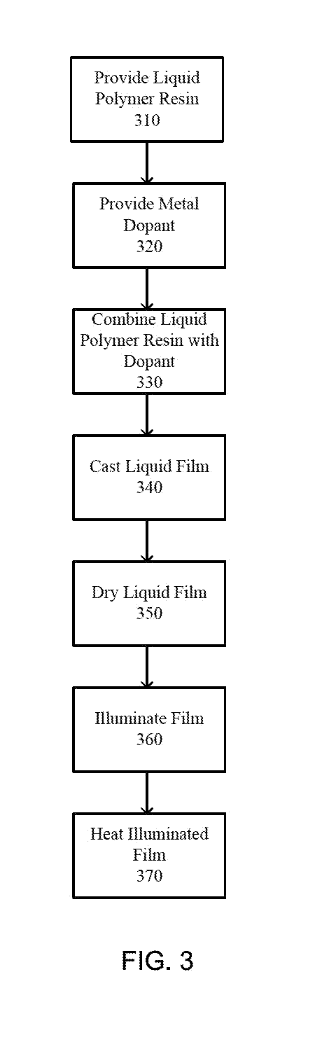

FIG. 3 is a flow chart of an embodiment of a method for fabricating a nanoparticle-polymer composite film. Initially, an uncured liquid polymer resin 310 may be provided. In one embodiment, the uncured polymer resin may comprise a mixture of at least one aromatic diamine and at least one aromatic dianhydride. Examples of aromatic diamines may include, without limitation, any one or more of phenylemediamine, benzidine, 4, 4′oxydianiline, 1,3-bis (4- aminophenoxy-4 ′benzoyl)benzene, 1,4-bis(4-aminophenoxy-4′benzoyl)benzene, 1,3-bis(aminophenoxy)benzene), diaminophenylmethane, diaminobenzophenone, di aminophenylsulfone , or 2,2-bis [4-(4-aminophenoxy)phenyl]hexafluoropropane. Examples of aromatic dianhydrides may include, without limitation, any one or more of 3,3′,4,4′-benzophenone tetracarboxylic dianhydride, 4,4′-isophthaloyldiphthalic anhydride, 3,3′4,4′-biphenlytetracarboxylic dianhydride, 2,2-bis(3,4′-dicarboxyphenyl)hexafluoropropane dianhydride, pyromellitic dianhydride, 4,4′-oxydiphthalic dianhydride, or 4,4′-bis(3,4-dicarboxy)diphenyl sulfide dianhydride.

In one non-limiting example, the uncured liquid polymer resin may comprise equimolar amounts of the one or more aromatic diamines and the one or more aromatic dianhydrides in a dry, polar, non-protic organic solvent. The solvent may be kept at a temperature from about the freezing point of the solvent to about 75° C. At the higher temperatures, the liquid polymer resin may be maintained under strictly anhydrous conditions such as being well-sealed and blanketed under an inert gas such as dry nitrogen or dry argon. In one non limiting embodiment, the liquid polymer resin may comprise equimolar amounts of at least one aromatic diamine and at least one aromatic dianhydride in a dry, polar, non-protic organic solvent at about room temperature, from about 68° F. (20° C.) to about 77° F. (25° C.) . The solvent may comprise, as non-limiting examples, one or more of dimethylacetamide, dimethylsulfoxide, hexamethylphosphoramide, N-methylpyrrolidone, 1,3-dimethyl-2-imidazolidinone, 1-cyclohexyl-2-pyrrolidone, 1-octyl-2-pyrrolidone, or bis(2-methoxyethyl)ether.

In addition to the uncured liquid polymer resin, a metal dopant may be provided, 320. The dopant may comprise at least one metal salt contacting a complexing agent. Examples of metals in the metal salt may include, without limitation, palladium, platinum, gold, silver, copper, cobalt, iron, or aluminum. The metal salt may further comprise one or more of a metal chloride, a metal bromide, or a metal iodide. In one embodiment, the complexing agent may comprise a dialkyl sulfide having a boiling point equal to or lower than about 250° C. Examples of such dialkyl sulfides may include, without limitation, any one or more of dimethyl sulfide, diethyl sulfide, dipropyl sulfide, dibutyl sulfide, or tetrahydrothiophene. The metal dopant may be fabricated by combining at least one complexing agent with at least one metal salt to form a solution, mixing the solution, and then removing unreacted material. The solution may be mixed in any number of ways, including but not limited to, stirring, shaking, and refluxing the solution. Unreacted material may be removed in any number of ways including, but not limited to, distilling, decanting, filtering, and lyophilizing the solution.

The uncured liquid polymer resin and the metal dopant may be combined to form a mixture, 330. The metal dopant may be added to the liquid polymer resin in a weight ratio of about 1% to about 5% metal dopant to liquid polymer. Examples of weight ratios of metal dopant to liquid polymer may include 1%, 2%, 3%, 4%, 5%, and ranges between any two of these values. Once the polymer/dopant mixture is formed, the liquid may be cast as a film onto a flat support, 340. In one embodiment, the film may be cast on the flat support by means of a doctor blade. In one embodiment, the support may comprise a flat solid material that transmits radiation having at least one wavelength from about 490 nm to about 570 nm, and does not transmit radiation having at least one wavelength from about 200 nm to about 400 nm. As one non-limiting example, the support may comprise soda lime glass. The support may have a thickness, for example about 0.01 inches (0.254 mm) thick, about 0.03 inches (0.762 mm) thick, about 0.05 inches (1.27 mm) thick, about 0.1 inches (2.54 mm) thick, about 0.2 inches (5.08 mm) thick, about 0.3 inches (7.62 mm) thick, about 0.4 inches (10.16 mm) thick, about 0.5 inches (12.7 mm) thick, and ranges between any two of these values.

The wet film cast on the support may then be dried, 350. In one embodiment, the wet film may be dried by passing a dry gas over the wet film. Non-limiting examples of such a gas may include dry air, dry nitrogen, dry helium, or dry argon. The film may be subjected to the drying process from about 1 hour to about 48 hours. Examples of drying times may include 1 hour, 2 hours, 5 hours, 8 hours, 10 hours, 12 hours, 15 hours, 18 hours, 20 hours, 24 hours, 30 hours, 36 hours, 40 hours, 48 hours, and ranges between any two of these values.

The dried film may then be subjected to illumination by radiation having at least one wavelength from about 490 nm to about 570 nm, 360. Examples of wavelengths may include 490 nm, 500 nm, 510 nm, 520 nm, 530 nm, 540 nm, 550 nm, 560 nm, 570 nm, and ranges between any two of these values. In one embodiment, the illumination may be uniform over the entire surface of the film. By uniform illumination, it is understood that the irradiance of the film by the illumination is about the same over the entire surface area. In one embodiment, the film may be illuminated by pressing against the film a flat covering layer that is uniformly coated on the non-contacting side with a matrix combined with at least one emissive dye. The dye may be caused to emit radiation having at least one wavelength from about 490 nm to about 570 nm. The emissive dye may be one that may absorb radiation at one excitation wavelength, and the matrix may be essentially transparent to the excitation wavelength. Examples of transparency may include greater than about 60% transmission at the excitation wavelength, greater than about 70% transmission, greater than about 80% transmission, greater than about 90% transmission or ranges between any two of these values. In one non-limiting example, the matrix may comprise an epoxy matrix. The matrix may have a uniform thickness from about 0.1 mm to about 10 mm Examples of matrix thickness may include 0.1 mm, 0.2 mm, 0.5 mm, 0.7 mm, 1.0 mm, 2.0 mm, 5.0 mm, 7.0 mm, 10.0 mm, and ranges between any two of these values.

An emissive dye is one that may absorb radiation at an excitation radiation wavelength, and emit radiation at a second, emitted, radiation wavelength. The excitation wavelength may include, without limitation, a wavelength from about 200 nm to about 400 nm. Examples of excitation wavelengths may include about 250 nm, about 280 nm, about 310 nm, about 340 nm, about 350 nm, about 360 nm, about 365 nm, about 370 nm, about 380 nm, and ranges between any two of these values. A number of emissive dyes may be used according to this disclosure. Non-limiting types of dyes may include one or more of an acridine dye, a bi-benzimidazole dye, an amino naphthalene sulfonic acid dye, an oxydiazole dye, a naphthyloxazole sulfonic acid dye, a hydroxyl oxoxanthenyl dye, a flavin dye, a stilbene dye, or a benzothiazole dye. Specific examples of dyes may include, without limitation, one or more of acriflavin, reosaniline hydrochloride, stilbene isothiosulfonate, bisbenzamide, dimethyl amino naphthalene sulfonic acid, diamino naphthalene sulfonic acid, diamino phenyl oxydiazole, dimethylamino sulfonic acid, dopamine, fluorescein, noradrenaline, pyrozal brilliant flavin, serotonin, auramine 0, coumarin 1, Hoechst 33258, rhodamine 123, tryptophan, or thioflavin TCN. The emissive dye may be mixed with the matrix in a weight proportion from about 1% by weight to about 50% by weight of the dye to the matrix. Examples of proportion of dye to matrix by weight may include 1%, 5%, 10%, 15%, 20%, 25%, 30%, 35%, 40%, 45%, 50%, and ranges between any two of these values.

The depth of the film interlayer may depend on the amount of radiation absorbed by the film and emitted by the dye. The emitted radiation, in turn, may depend on the amount of excitation radiation received by the dye. In one embodiment, the dye may be exposed to radiation at an excitation wavelength for about 1 hour, 2 hours, 3 hours, or for a time between any two of these values.

One side of the flat covering layer may be uniformly coated with a combination of the matrix and emissive dye. In one embodiment, the covering layer may be effectively transparent to radiation emitted by the emissive dye, but effectively opaque to the radiation at the dye excitation wavelength. In one embodiment, the covering layer may be effectively transparent to radiation having a wavelength of about 490 nm to about 570 nm. In one embodiment, the transmittance of radiation of about 490 nm to about 570 nm may be greater than about 60%. In another embodiment, the transmittance of radiation of about 490 nm to about 570 nm may be greater than about 80%. In yet another embodiment, the transmittance of radiation of about 490 nm to about 570 nm may be greater than about 90%. In one embodiment, the covering layer may be effectively opaque to radiation having a wavelength of about 200 nm to about 400 nm. In another embodiment, the covering layer may be effectively opaque to radiation having a wavelength of less than about 300 nm. In one embodiment, the transmittance of radiation less than about 300 nm may be less than about 50%. In another embodiment, the transmittance of radiation less than about 300 nm may be less than about 20%. In yet another embodiment, the transmittance of radiation less than about 300 nm may be less than about 10%. In still another embodiment, the covering layer may comprise soda lime glass.

Once the film has been illuminated, the film may be heat cured, 370. In one embodiment, the film may be heat cured in a forced air oven. The film may be heated from about 100° C. to about 300° C. in order to remove excess solvent and water due to polymerization. Examples of heating temperatures may include 100° C., 120° C., 140° C., 160° C., 180° C., 200° C., 220° C., 240° C., 260° C., 280° C., 300° C., and ranges between any two of these values. The heat curing process may include heating the film at a single temperature, heating the film in several distinct temperature steps, or heating the film by ramping the temperature from a low value to a high value and back down to a low value. In one non-limiting embodiment, the film may be heated at about 100° C. for about one hour, followed by heating at about 200° C. for about one hour, followed by heating at about 300° C. for about one hour, and then allowing the film to cool to ambient temperature. It may be understood that the film may be heated according to any of a number of different temperature protocols to cure the film into a final state.

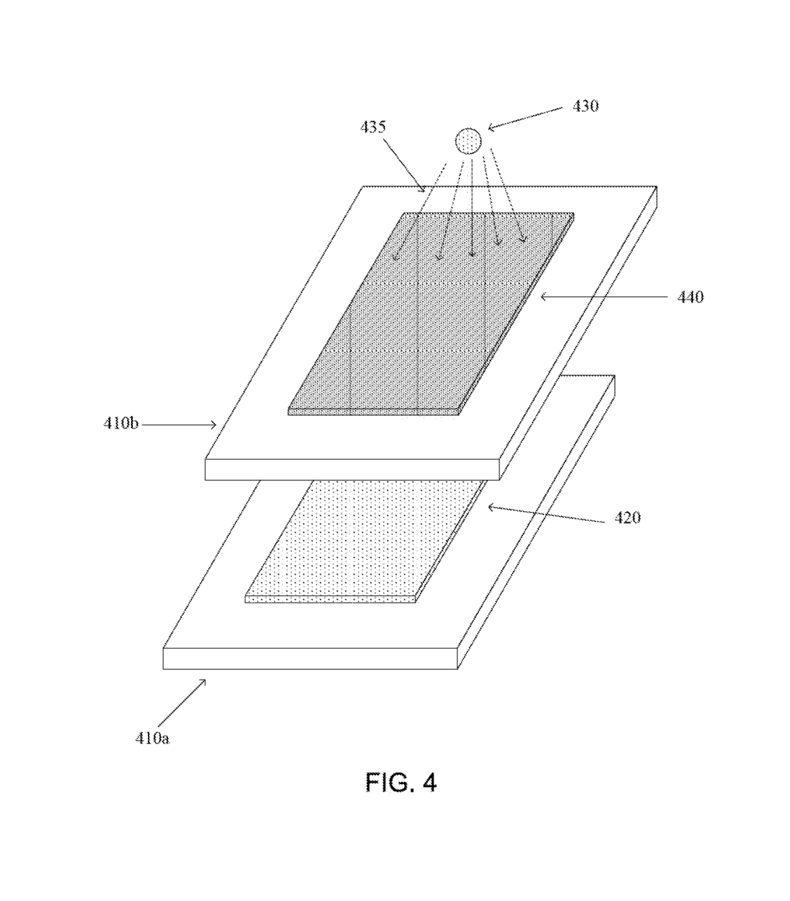

As disclosed above, it is believed that the depth of an interlayer of nanoparticle metal in the composite film may be related to the amount of radiation impinging on the film. As a result, an interlayer with uniform depth within the film may be produced by uniformly illuminating the film. It may be appreciated that a light source comprising a light bulb (such as from a UV illumination source) may not be able to provide such uniform illumination since the distance from the bulb to the film would not be uniform across the entire film surface. As a result, a system for providing uniform illumination would be useful for creating a uniform interlayer depth. FIG. 4 illustrates one non-limiting embodiment of a system to provide uniform illumination for the film.

In FIG. 4, the uncured film containing the dispersed metal compound 420 may be placed between two flat supports 410a-b. In some embodiments, the film may be compressed between the supports. As one non-limiting example, a film 420 may be placed between the supports 410a-b and the supports and film may be taped together to form a compressed structure. In another embodiment, one of the supports, 410a, may simply provide a surface on which the film may be laid. The second support 410b may have a first flat side to contact the film, while the opposing, second side, may be coated with a uniformly thick layer of a light emitting material 440. The second flat support 440 may be fabricated of a material essentially transparent to the wavelength of radiation emitted by the light emitting material. The system may also include a source of excitation radiation 430 capable of providing light 435 that may cause the light emitting material to emit radiation and illuminate the film. In one embodiment, the excitation radiation source 430 may emit radiation having a wavelength from about 200 nm to about 300 nm.

The second flat support 410b may be fabricated from a material that is also essentially opaque to the excitation radiation. In one embodiment, support 410b may be effectively opaque to radiation having a wavelength from about 200 nm to about 300 nm. In one embodiment, the transmittance of radiation from about 200 nm to about 300 nm may be less than about 50%. In some embodiments, the transmittance of radiation from about 200 nm to about 300 nm may be less than about 20%. In yet another embodiment, the transmittance of radiation from about 200 nm to about 300 nm may be less than about 10%. In Support 410b may also be effectively transparent to light emitted by the light emitting material, such as, for example, from about 490 nm to about 570 nm. In one embodiment, the transmittance of radiation of about 490 nm to about 570 nm may be greater than about 60%. In another embodiment, the transmittance of radiation of about 490 nm to about 570 nm may be greater than about 80%. In yet another embodiment, the transmittance of radiation of about 490 nm to about 570 nm may be greater than about 90%.

The two flat supports 410a-b may be made of the same material or different materials. In one embodiment, the two flat supports may be fabricated from soda lime glass.

The light emitting material 440 may comprise any of a number of types of materials able to emit light. In one non-limiting embodiment, the light-emitting material may comprise a combination of a matrix mixed with at least one light emitting dye. The light-emitting material may be fabricated of a weight percent mixture of dye to matrix material of about 1% to about 50%. The light emitting material 440 may have an effectively uniform thickness of about 0.5 mm to about 10 mm Examples of uniform thickness may include 0.5 mm, 1 mm, 2 mm, 3 mm, 4 mm, 5 mm, 6 mm, 7 mm, 8 mm, 9 mm, 10 mm, and ranges between any two of these values. In a non-limiting embodiment, the matrix may comprise an epoxy material such as a diglycidyl ether of bisphenol A. The light emitting dye may be composed of any one or more of the light-emitting dyes disclosed above. In one non-limiting example, the dye may be fluorescein.

It should be understood that methods and systems such as those disclosed above that may include the use of an emissive dye for illuminating an uncured polymer film may take on a variety of alternative embodiments. In one embodiment, the emissive dye may comprise fluorescein, which may be incorporated into an epoxy matrix uniformly laid on a soda lime glass support. Fluorescein has at least one excitation (absorbance) wavelength at around 225 nm, and may emit light at around 517 nm or around 538 nm. In this embodiment, excitation radiation at around 225 nm may excite the fluorescein, which may emit green light at around 517 nm. The soda lime glass may block the UV excitation radiation (225 nm), but may permit the green emitted light (517 nm) to expose the film.

A similar embodiment may use Rhodamine 123 as the emissive dye. Rhodamine 123 has an excitation (absorbance) wavelength of about 230 nm, and emits radiation at around 550 nm. Light at this wavelength may be perceived as having a more yellow-green color than the light emitted by fluorescein. This disclosure anticipates that the radiation used for developing the polymer interlayer may encompass radiation having perceptible colors that may differ from green.

Further, this disclosure also anticipates more complex dye systems, such as the use of multiple dyes to illuminate the film. Such multi-dye systems and methods may include a first emissive dye and a second emissive dye. The first dye may be excited at a first excitation wavelength by a light source, and subsequently emit radiation at a first emission wavelength. The first emission wavelength may be sufficiently close to an excitation wavelength of the second dye that the second dye may be caused to emit radiation at a second emission wavelength. The uncured film may then be exposed to the second emission wavelength. In one anticipated embodiment, the multiple dyes may be mixed together within the same matrix layer. In another anticipated embodiment, each dye may be incorporated into its own layer so that the radiation emitted by a first dye layer may excite a second dye incorporated into an underlying matrix layer.

### EXAMPLES

### Example 1

### A Method for Producing Surface-Conductive Light-Responsive Nanoparticle-Polymer Composites

An uncured liquid polymer resin was prepared by mixing equimolar amounts of 3,3′,4,4′-benzophenone tetracarboxylic dianhydride and 4,4′ -oxydianiline in dimethylacetamide to form a 15% by weight polyamic acid solution. The solution was mixed for about 1 to about 2 hours at room temperature under conditions to exclude water from the solution. Thus, all solvents and reagents were anhydrous, and were combined and mixed under an inert gas such as argon. The solution was blanketed under an inert gas and stored under refrigeration. The metal dopant was prepared by refluxing dimethyl sulfide (boiling point about 38° C.) with palladium (II) chloride for about 3 hours, after which the unreacted solvent was distilled from the product. The reaction provided about 90% yield of PdCl₂(SMe₂)₂. The palladium salt was added to the liquid polymer resin to produce an about 5% by weight metal doped polymer solution.

A film of the metal doped polymer solution was cast on a soda-lime glass plate to produce a film about 0.02 inches (0.508 mm) thick, about 8 inches (203 mm) wide, and about 12 inches (305 mm) long. The film was cast using a doctor blade to produce a uniformly thick film. The film on the plate was then dried in a low humidity dry box under a slow flow of dry air for about 24 hours. The dried film on its support was placed in the center of a commercially available UV irradiation chamber. It was noted that the irradiation chamber had a central cavity for the specimen, surrounded by a group of UV emitting bulbs. Measurements of the luminous flux received by the flat film sample in the chamber indicated non-uniform irradiation across the area of the film due to the geometry of the film with respect to the combined UV light sources. The support glass carrying the film was fixed in place inside the chamber by using an epoxy glue to secure the underside of the plate to a metal rod. The chamber irradiated the structure at about 250 nm for about lhour to about 3 hours. The photon flux of the UV irradiation source was about 1.65×10¹⁶ photons/sec/cm³ at a wavelength of about 253 nm. The soda lime glass support appeared to prevent the UV light from illuminating the film on the contact side. However, it was noticed that an interlayer formed on the bottom side of the film contacting the glass plate at around the point immediately above the epoxy glue bolus. It was determined that the epoxy glue contained a small amount of fluorescein marker dye that could emit radiation at about 517 nm when exited by the UV radiation.

After the film was irradiated, the glass plate with the epoxy/dye material was carefully removed from the irradiated film, and the film was carefully peeled away from the lower glass plate with a razor blade. The free film was then suspended in a forced air oven for thermal curing. The temperature in the oven was ramped from about 100° C. to about 200° C. to about 300° C., the temperature being held at each point for about an hour. After the final curing at 300° C., the film was cooled back to room temperature over a period of about 2 hours.

A film produced by this method has been characterized as having a thickness of about 25 μm and a weight of about 25 g/m². The glass transition temperature (Tg) was about 250° C. Thermogravimetric analysis of the film demonstrated a 10% weight loss at about 305° C. The metal layer on the conductive side of the film had a thickness of about 25 nm, with a surface conductivity from about 10 millisiemens (mS) to about 5 siemens (S), depending on the amount of metal dopant in the original liquid resin.

### Example 2

### A Method for Producing Surface-Conductive Light-Responsive Nanoparticle-Polymer Composites Using a Uniform Layer of a Light Emitting Material

A method similar to that presented in Example 1, above, may include covering the top of the dried polymer film with a second soda glass plate uniformly coated with a mixture of an epoxy comprising a diglycidyl ether of bisphenol A admixed with fluorescein dye in a percent weight mixture of about 5% dye to epoxy matrix. The two plates may be fixed together with a temperature resistant tape to form a sandwich structure with the film compressed between the two plates. The structure may then be loaded into the center of the UV illumination chamber and illuminated for about 1 to about 3 hours. The top glass plate may be carefully removed and the illuminated film may then be processed as disclosed above in Example 1.

### Example 3

### A System for Uniform Illumination of a Nanoparticle-Polymer Composite Using a Single Emissive Dye

A system for uniformly illuminating a metal-doped polymer film may comprise a first flat plate of soda lime glass on which the film may be supported. The system may also include a second flat plate of soda lime glass on which is spread a uniform layer of epoxy mixed with about 5% by weight fluorescein dye. The un-polymerized epoxy/dye layer may be spread to a uniform thickness of about 1 mm on the second glass plate by using a doctor blade, and the layer may be allowed to cure before use. The system may additionally include a source of UV illumination centered at around 250 nm. A commercially available UV illumination chamber may be used as this component of the system. The system may be assembled by placing the film sample on the first soda lime glass plate, placing the second glass plate on the film with the epoxy/dye layer not contacting the film, sealing the two plates together to form a sandwich structure with the film between the two plates, and placing the sandwich structure inside the UV illumination chamber.

### Example 4

### A System for Uniform Illumination of a Nanoparticle-Polymer Composite Using Multiple Emissive Dyes

A system for uniformly illuminating a metal-doped polymer film may comprise a first flat plate of soda lime glass on which the film may be supported. The system may also include a second flat plate of soda lime glass on which is spread a uniform layer of epoxy mixed with a combination of about 5% by weight tryptophan and about 5% by weight Hoechst 33258 stain. Tryptophan may be excited by radiation at about 210 nm or about 270 nm, and may emit radiation at about 355 nm. Hoechst 33258 may be excited by radiation about 340 nm and may emit radiation at around 510 nm. Thus the radiation emitted by the tryptophan may be used to cause the Hoechst 33258 to emit a green-colored light. The un-polymerized epoxy/dye layer may be spread to a uniform thickness of about 1 mm on the second glass plate by using a doctor blade, and the layer may be allowed to cure before use. The system may additionally include a source of UV illumination centered at around 210 nm or around 250 nm. A commercially available UV illumination chamber may be used as this component of the system. The system may be assembled by placing the film sample on the first soda lime glass plate, placing the second glass plate on the film with the epoxy/dye layer not contacting the film, sealing the two plates together to form a sandwich structure with the film between the two plates, and placing the sandwich structure inside the UV illumination chamber.

### Example 5

### A System for Uniform Illumination of a Nanoparticle-Polymer Composite Using Multiple Dye Layers

A system for uniformly illuminating a metal-doped polymer film may comprise a first flat plate of soda lime glass on which the film may be supported. The system may also include a second flat plate of soda lime glass on which is spread multiple uniform layers of epoxy, each layer mixed with an emissive dye. For example, Auramine 0, which may absorb radiation at about 430 nm and may emit radiation at about 500 nm, may be mixed at about 5% by weight with the epoxy in a first layer on the glass. The first layer may then be allowed to cure. A second layer, containing about 5% by weight coumarin 1, which may absorb radiation at about 240 nm and emit radiation at about 447 nm, may be mixed with epoxy on a second layer laid down over the first epoxy/dye layer and allowed to cure. Each un-polymerized epoxy/dye layer may be spread to a uniform thickness of about 1 mm by using a doctor blade, and the layers may be allowed to cure before use. In this system, the coumarin 1 in the second epoxy/dye layer may be illumined by a source of UV radiation centered around 240 nm. The coumarin 1 may then emit radiation at about 447 nm into the first epoxy-dye layer. The Auramine 0 in the first layer may then absorb some of the 447 nm radiation emitted by the coumarin 1 and emit green light at about 500 nm to illuminate the film below the second flat plate. The system may additionally include a source of UV illumination centered at around 240 nm. A commercially available UV illumination chamber may be used as this component of the system. The system may be assembled by placing the film sample on the first soda lime glass plate, placing the second glass plate on the film with the multiple epoxy/dye layers not contacting the film, sealing the two plates together to form a sandwich structure with the film between the two plates, and placing the sandwich structure inside the UV illumination chamber.

### Example 6

### Use of a Nanoparticle-Polymer Composite

The composite material may respond to light, or to the heat generated by light impinging on the surface of the composite, and may bend preferentially in the direction towards the conductive surface. Therefore, one use of the composite may be as a sensor for light or heat. For example during its operation, a circuit board may generate some amount of heat due to resistive losses in the components. A small ribbon of the composite film associated with the circuit board may sense the heat, causing it to bend towards its conductive surface. This action may allow the conductive side of the composite film to touch an electrical contact, thereby completing a circuit that may sound an audible alarm that the circuit board is overheating.

Further, because the motion of the film is reversible, a pulsed light or heat source may cause the film composite to move reversibly, thereby providing a light/heat activated motor or valve. In addition, the optical properties of the colored side of the film may make it useful as a reflective display. Small motions of the film due to inhomogeneous heating on the conductive side may result in small physical distortions of the film detectable on the colored side as changes to light reflectance (such as color or polarization).

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in this disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used in this disclosure is for the purpose of describing particular embodiments only, and is not intended to be limiting.

With respect to the use of substantially any plural and/or singular terms in this disclosure, those having skill in the art can translate from the plural to the singular and/or from the singular to the plural as is appropriate to the context and/or application. The various singular/plural permutations may be expressly set forth in this disclosure for sake of clarity. It will be understood by those within the art that, in general, terms used in this disclosure, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ^{at} ₗₑₐₛₜ ^{one} _{and} ^{one} ₒᵣ ^{more} to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed in this disclosure also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this disclosure can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

1. A method of fabricating a nanoparticle-polymer composite, the method comprising:
providing an uncured liquid polymer resin;
providing at least one metal dopant;
combining the uncured liquid polymer resin with the at least one metal dopant to form a liquid polymer/metal mixture;
casting a film of the liquid polymer/metal mixture onto a flat support;
drying the film;
uniformly illuminating the dried film with radiation having at least one wavelength from about 490 nm to about 570 nm; and
heating the illuminated film.

2. The method of claim 1, wherein the uncured liquid polymer resin comprises a mixture of at least one aromatic diamine and at least one aromatic dianhydride.

3.-4. (canceled)

5. The method of claim 2, wherein providing an uncured liquid polymer resin comprises combining equimolar amounts of the at least one aromatic diamine and the at least one aromatic dianhydride in a dry, polar, non-protic organic solvent at a temperature from about a freezing point of the solvent to about 75° C.

6.-7. (canceled)

8. The method of claim 1, wherein providing the at least one metal dopant comprises contacting at least one metal salt with at least one complexing agent.

9.-10. (canceled)

11. The method of claim 8, wherein the at least one complexing agent is a dialkyl sulfide having a boiling point less that about 250° C.

12. (canceled)

13. The method of claim 8, wherein contacting the at least one metal salt with the at least one complexing agent comprises:
combining the at least one complexing agent and the at least one metal salt to form a metal/complex solution;
mixing the metal/complex solution; and
removing any unreacted complexing agent.

14.-15. (canceled)

16. The method of claim 1, wherein an amount of the at least one metal dopant combined with the uncured liquid polymer resin is about 1% to about 5% by weight of an amount of the uncured liquid polymer resin.

17. (canceled)

18. The method of claim 1, wherein the support comprises a flat solid material that transmits radiation having at least one wavelength from about 490 nm to about 570 nm, and does not transmit radiation having at least one wavelength from about 200 nm to about 400 nm.

19. (canceled)

20. The method of claim 1, wherein the film has a thickness of about 0.01 inches (0.254 mm) to about 0.03 inches (0.762 mm).

21. (canceled)

22. The method of claim 1, wherein drying the film comprises slowly passing a dry gas over the film.

23. (canceled)

24. The method of claim 22, wherein passing a dry gas over the film comprises passing a dry gas over the film for about 1 hour to about 48 hours.

25. (canceled)

26. (canceled)

27. The method of claim 1, wherein illuminating the dried film with radiation having at least one wavelength from about 490 nm to about 570 nm comprises:
providing a flat covering layer, having a first side and a second side, wherein the first side is uniformly coated with a matrix combined with at least one emissive dye;
pressing the second side of the flat covering layer against the dried film; and
causing the at least one emissive dye to emit at least one radiation having at least one wavelength from about 490 nm to about 570 nm.

28. The method of claim 27, wherein the at least one emissive dye absorbs an energy at an at least one excitation wavelength, and the matrix comprises a material essentially transparent having a transmission greater than about 90% at the at least one excitation wavelength.

29. The method of claim 28, wherein essentially transparent comprises having a percent transmission greater than about 60% at the at least one absorption wavelength.

30.-31. (canceled)

32. The method of claim 27, wherein the matrix comprises an epoxy.

33. The method of claim 27, wherein the at least one emissive dye is one or more of: an acridine dye, a bi-benzimidazole dye, an amino naphthalene sulfonic acid dye, an oxydiazole dye, a naphthyloxazole sulfonic acid dye, a hydroxyl oxoxanthenyl dye, a flavin dye, a stilbene dye, and a benzothiazole dye.

34. (canceled)

35. The method of claim 27, wherein the matrix has a uniform thickness from about 0.1 mm to about 10 mm.

36.-38. (canceled)

39. The method of claim 27, wherein the flat covering layer has a transmittance greater than about 90% to radiation having at least one wavelength of about 490 nm to about 570 nm, and has a transmittance less than about 10% to radiation having at least one wavelength of about 200 nm to about 400 nm.

40. The method of claim 27, wherein causing the at least one emissive dye to emit at least one radiation comprises illuminating the at least one emissive dye with an excitation radiation.

41. The method of claim 40, wherein the excitation radiation comprises radiation having at least one wavelength from about 200 nm to about 400 nm.

42. (canceled)

43. The method of claim 27, wherein the flat covering layer comprises a material having a transmittance less than about 10% to a radiation having at least one wavelength smaller than about 300 nm.

44. The method of claim 27, wherein the flat covering layer comprises a material having a percent transmittance of less than about 50% to a radiation having at least one wavelength smaller than about 300 nm.

45.-47. (canceled)

48. The method of claim 1, wherein heating the illuminated film comprises heating the film to a temperature from about 100° C. to about 300° C.

49.-50. (canceled)

51. A system to uniformly illuminate a film, the system comprising:
a first flat support having a first side;
a second flat support having a first side and a second side, wherein the second side is coated with an effectively uniform thickness of at least one light-emitting material and the second flat support comprises at least one material effectively transparent to radiation having at least one wavelength of a light emitted by the light-emitting material; and
at least one source of an excitation radiation configured to cause the at least one light-emitting material to emit the radiation.

52. (canceled)

53. The system of claim 51, wherein the at least one light-emitting material comprises a matrix mixed with at least one dye.

54.-56. (canceled)

57. The system of claim 53, wherein an amount of the at least one dye mixed with the matrix is about 1% by weight to about 50% by weight of an amount of the matrix.

58. The system of claim 51, wherein the second flat support is effectively transparent to radiation having at least one wavelength of about 490 nm to about 570 nm, and is effectively opaque to radiation having at least one wavelength of 200 nm to about 400 nm.

59. The system of claim 51, wherein the at least one source of the excitation radiation is configured to emit radiation having at least one wavelength from about 200 nm to about 400 nm.

60. The method of claim 27, wherein causing the at least one emissive dye to emit at least one radiation having at least one wavelength from about 490 nm to about 570 nm comprises:
combining in the matrix a first emissive dye and a second emissive dye;
exposing at least the first emissive dye to at least one wavelength from about 200 nm to about 400 nm, thereby causing the first emissive dye to emit a first emitted radiation; and
configuring the second emissive dye to absorb at least a portion of the first emitted radiation, thereby causing the second emissive dye to emit at least one radiation having at least one wavelength of about 490 nm to about 570 nm.
